(19) United States
(12) Patent Application Publication
(10) Pub. No.: US 2013/0276411 A1
(43) Pub. Date: Oct. 24, 2013

(54) VENDING MACHINE, PARTICULARLY FOR COLD DRINKS

(71) Applicants: Gian Luca Casadio Prati, Imola (IT); Gian Marco Casadio Prati, Imola (IT)

(72) Inventors: Gian Luca Casadio Prati, Imola (IT); Gian Marco Casadio Prati, Imola (IT)

(21) Appl. No.: 13/823,536

(22) PCT Filed: Sep. 15, 2011
(86) PCT No.: PCT/EP11/66041

§ 371 Date: Jul. 2, 2013

(30) Foreign Application Priority Data
Sep. 24, 2010 (IT) BO2010A000573

(51) Int. Cl. B67D 1/00

(52) U.S. Cl. CPC B67D 1/0034
USPC 53/467; 222/129.1; 141/105; 141/98

(57) ABSTRACT

A vending machine, particularly for cold drinks, comprising at least one main water tank, at least one storage compartment for at least one water-soluble preparation and at least one apparatus for mixing the preparation in water, to provide a beverage, obtained by mixing the preparation in the water, which can be dispensed to the exterior.

### TECHNICAL FIELD

The present invention relates to a vending machine, particularly for cold drinks.

### BACKGROUND ART

Nowadays, machines are widely available on the market that are capable of dispensing and distributing, typically after the payment of a predefined amount, various food products (and other products as well).

As is known, these machines are usually box-like in shape and inside them there are various mechanisms that are capable of issuing, upon the user's request, snacks, fresh foods, hot beverages (coffee, hot chocolate etc.), cold beverages (water, drinks in cans, fruit juices etc.) or other products, stored in adapted receptacles.

The vending machines described above are typically installed in proximity to public places, offices, industrial factories and the like, thus making a more or less wide range of products available to users even when no commercial concerns for the sale thereof are present.

These implementation solutions are not devoid of drawbacks.

The space available inside the vending machine, for accommodating the supplies of the various products, is inevitably limited by the elements given over to its operation. Since supplies for each type of product (often bulky, as with cans or bottles) must necessarily be accommodated in this limited space, it seems evident that it is not possible to ensure the permanent availability of the desired article, in particular for articles with a high rotation, except by frequent restocking of the amounts, performed by a member of staff who is thus required to frequently go to the installation site of the vending machine.

The foregoing inevitably leads to an increase in the running costs associated with the vending machine, which in turn contribute to raising the final price of the entire vending machine, until it is rendered uneconomic, or in any case reducing the demand for them.

Moreover, it is precisely the factors discussed above that prevent vending machines from being installed in condominiums or in other places that are accessible to a smaller number of potential users, precisely because the running costs and the need to frequently restock the supply levels would result in totally unacceptable costs and restocking of individual products.

### DISCLOSURE OF THE INVENTION

The aim of the present invention is to solve the above-mentioned problems, by providing a vending machine that enables the simple and economical management of the supplies of products located therein.

Within this aim, an object of the invention is to provide a vending machine that is adapted for installation in condominiums and in public places that are not heavily frequented.

Another object of the invention is to provide a vending machine that can operate fully respecting the environment and which ensures an easy disposal of the containers utilized.

Another object of the invention is to provide a vending machine that ensures a high reliability of operation.

Another object of the invention is to provide a vending machine that can be easily implemented using elements and materials that are readily available on the market.

Another object of the invention is to provide a vending machine that is low-cost and safely applied.

This aim and these and other objects which will become better apparent hereinafter are achieved by a vending machine, particularly for cold drinks, characterized in that it comprises at least one main water tank, at least one storage compartment for at least one water-soluble preparation and at least one apparatus for mixing said preparation in said water to provide a beverage, obtained by mixing said preparation in said water, which can be dispensed outside,

### BRIEF DESCRIPTION OF THE DRAWINGS

Further characteristics and advantages of the invention will become more apparent from the following detailed description of a preferred, but not exclusive, embodiment of the vending machine according to the invention, which is illustrated for the purposes of non-limiting example in the accompanying drawings wherein:

FIG. 1 is a block diagram that illustrates the structure of the vending machine according to the invention;

FIG. 2 is an exploded perspective view of an element contained in the vending machine according to the invention;

FIG. 3 is a perspective view of the storage of respective parts of a plurality of elements of the same type as those in FIG. 2.

### WAYS OF CARRYING OUT THE INVENTION

With reference to the figures, a vending machine according to the invention, generally designated with the reference numeral 1, is typically (but not necessarily) provided with a box-like outer casing and, installed in or in proximity to public places, shops, offices, hotels, service stations and even (as we shall see below) condominiums, makes a more or less wide range of products available to those present. More precisely, the vending machine 1 is particularly suitable for dispensing cold drinks, like mineralized waters (or the like, both still and with carbon dioxide added), colas, fruit juices, iced teas etc. Therefore it is to such application that reference will be made hereinafter in this discussion, but the use of the vending machine 1 according to the invention for offering other products to the public as well (with or without cold drinks) is not excluded, according to specific requirements.

It should be noted that the methods for dispensing and choosing the products can be those of the known type, and therefore the vending machine I can be provided with an electronic control and management unit 2 capable of activating the various components (which will be described below), in order to deliver the product. This delivery preferably occurs following a command issued by the user, by means of one or more adapted keypads 2a, arranged on an outer face of the casing, and after the user has inserted the required number of coins or banknotes into a slot, provided in a payment module 2b which can be of the known type.

The payment module 2b (or even the keypad 2a) can moreover have a port adapted to receive a prepaid key substantially of the known type, adapted to pay the predefined amount instead of banknotes and coins.

According to the invention, the vending machine 1 comprises at least one main water tank 3, at least one storage compartment 4 for at least one water-soluble preparation and at least one apparatus 5 for mixing the preparation in water. By the mixing of these substances (which can occur in another collection tank), it is thus possible to obtain, only after the user's request, the required beverage, which can thus be dispensed to the exterior (in various ways, as will be shown in the following paragraphs).

In particular, the preparation is preferably selected from among a fruit-based concentrate (to provide a beverage of the type of a fruit juice), a syrup for providing beverages of the type of a cola, and a compound based on mineral salts (to provide water of the type of mineralized water, table water, purified water, water with added salts), and the like.

Moreover, preparations can be used that are capable of adding carbon dioxide to the water contained in the main tank 3, as well as other substances that are suitable for the preparation of different types of water.

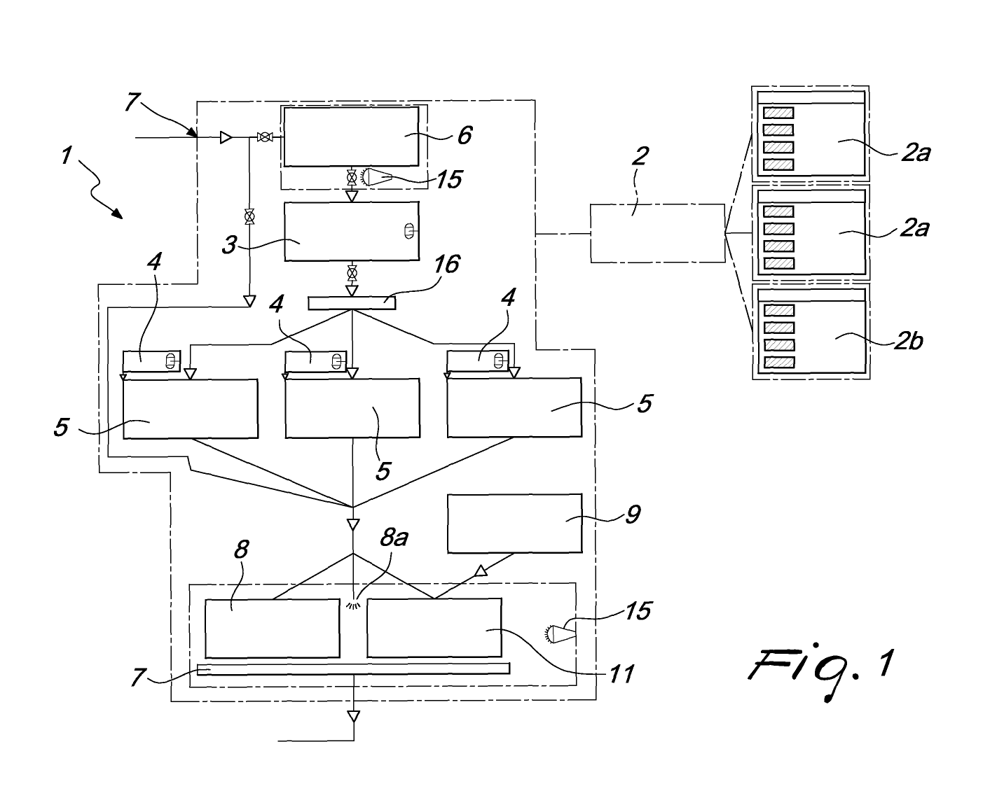

Moreover, the possibility is not ruled out of providing the vending machine 1 with a plurality of compartments 4 for the storage of corresponding preparations. For example the embodiment shown in FIG. 1 proposes (while not limiting the application of the invention) a vending machine 1 provided with three different compartments 4 (associated with respective mixing apparatuses 5), for storing three different preparations and therefore enabling the supply of three different beverages depending on the user's choice.

It is clear from this point onward that the choice to use a main tank 3 and one or more compartments 4, for storing water and the other ingredients (preferably in powdered form or in the liquid state) necessary for providing the beverages, makes it possible to perceptibly reduce the space given over to storing the products to be dispensed.

In fact, differently from what occurs in vending machines of the known type, wherein bottles of finished product are stored, in the vending machine 1 according to the invention it is sufficient to accommodate the ingredients (which typically occupy considerably less space).

Moreover, for the same space occupied, the supplies of raw material are such as to ensure the dispensing of a very high number of products (since for each one of them a small dose of preparation is sufficient) and thus the need for frequent visits by a member of staff for restocking the supplies is eliminated, therewith achieving the set aim.

Conveniently, the vending machine 1 according to the invention can comprise a water purifying device 6, which is interposed between the main water tank 3, which is preferably refrigerated, and a port 7 for introducing mains water, which is provided in the vending machine 1 and can be connected to a water mains.

In particular, the purification device 6 is preferably selected from a reverse osmosis demineralizer, an electrode ionization demineralizer, and an activated carbon filter. Moreover, it is possible to adopt vending machines 1 provided with two or more of the devices 6 listed above, or with further types thereof, according to specific requirements.

The choice to use a water purifying device 6 makes it possible to connect the vending machine 1 to the water mains, to thus be able to supply the main tank 3 with substantially pure water, obtained by purifying mains water with the device 6. The pure water thus obtained can be used for the provision (adding the proper preparation and/or carbon dioxide) of the selected beverage or of mineralized water (or other, similar types of water, like those listed earlier), without the need for intervention by a member of staff for the constant refilling of the main tank 3, but instead it is possible, without additional running costs, to rely on a supply (guaranteed by the water mains) that is substantially inexhaustible.

Differently from what occurs with vending machines of the known type therefore, the operation of the vending machine 1 according to the invention and the possibility of satisfying the user's requests can be ensured without needing frequent and periodic visits by a member of staff to restock the desired quantities of supplies.

According to a first embodiment, the vending machine 1 comprises at least one spout 8 for dispensing the beverage, which is arranged downstream of the mixing apparatus 5 and is adapted to fill a container (for example, a bottle) of any desired type which is provided by a user.

According to a different embodiment, the vending machine 1 comprises at least one receptacle 9 for a plurality of containers 10 and packaging means 11 for each one of the containers 10, so that they can be filled with a predefined quantity of beverage, and optionally closed, prior to delivery to the user.

Moreover the possibility is not ruled out (and falls within the scope of protection claimed herein) of providing the vending machine 1 both with at least one spout 8, and with packaging means 11, if the specific applicative requirements make it preferable.

Moreover, the spout 8 (and other components, according to specific requirements) can be affected by the action of a washing nozzle 8a, optionally supplied with water taken from the main tank 3 or directly from the mains, to ensure its constant cleaning.

According to an embodiment of important practical interest, cited for the non-limiting purpose of illustrating the application of the invention, each container 10 is substantially constituted by at least one first portion 12 and at least one closure 13, which can be stably associated with the first portion 12 (by way of the packaging means 11), for the hermetic closure of the container 10.

At least the first portions 12 can be stacked on top of each other, so that they can be stored in the corresponding receptacle 9 in a configuration of minimum space occupation.

According to a first possible embodiment (which does not limit the application of the invention), such containers 10, and in particular such first portions 12, in the configuration for use, are substantially box-like in shape, and can be folded, so they can be stored in the folded configuration, which forms the above-mentioned minimum bulk configuration (and in which their faces are substantially mutually overlaid). In this way, only when it is necessary to dispense a beverage to the outside, the first portions 12, stored in the folded configuration, are brought to the configuration for use, for example by the packaging means 11.

According to a different embodiment, at least the first portions 12 are constituted by bags made of limp or semirigid material and provided with a substantially rigid base, so as to be maintained stably in a substantially erect position (such bags are known on the market as “stand-up pouches”).

Also according to this solution, it is possible to ensure the storage of the first portions 12 in a configuration of minimum space occupation, for example by creating inside them a partial vacuum sufficient to lead to a reduction of the volume occupied (and suitable to ensure they are maintained in conditions of total hygiene).

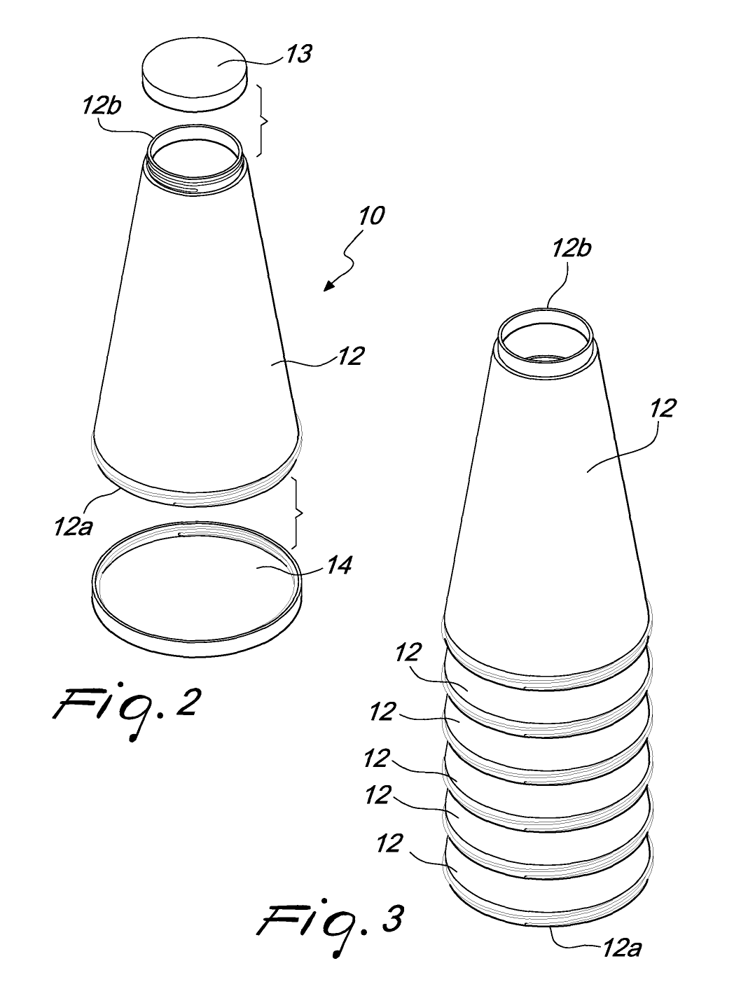

According to a third embodiment, shown in FIGS. 2 and 3, each first portion 12 is substantially frustum-shaped and open at its end faces 12a, 12b, so as to be able to be stacked to form a column which is arranged preferably in a substantially vertical manner (shown in FIG. 3), which defines the above-mentioned minimum bulk configuration.

According to this embodiment, each container 10 comprises a second portion 14, which is adapted to close (for example by means of a threaded coupling or other shape-based coupling provided by the packaging means 11) the corresponding lower end face 12a of the first portion 12, so as to enable the filling of the container 10 even when it is in the minimum bulk configuration. The closure 13 is thus adapted to hermetically close the container 10 (also according to known methods and/or for example by means of a threaded coupling or other shape-based coupling) at the corresponding upper end face 12b of the first portion 12, so as to then provide for its extraction from the column and delivery to the user.

Conveniently, the vending machine 1 according to the invention comprises a labeling assembly, associated with the packaging means 11, capable of applying labels of various types, which can also be preprinted, on at least one face of each container 10, prior to delivery to the user.

Advantageously, the vending machine 1 according to the invention comprises at least one source of ultraviolet radiation 15, preferably directed toward at least one from among the water purifying device 6, the spout 8 and the packaging means 11, for sanitizing these components (and also the water and the beverages obtained). Moreover, the possibility is not ruled out of providing vending machines 1 equipped with two or more sources 15 (for example of the type of lamps, also of the known type) directed toward two or more of the aforementioned components (or other components, from among those comprised in the vending machine 1 according to the invention).

The operation of the vending machine according to the invention is as follows.

The user's choice of beverage by means of the keypad 2a (and the payment of the predefined amount by means of the module 2b) determine the activation of the electronic unit 2, which thus actuates the apparatus 5. The apparatus 5 then provides for mixing the preparation with water supplied from the main tank 3, in this way providing the desired beverage, which is then delivered to the user in the container 10 or dispensed through the spout 8 and thus poured into a container provided by the user,

As has been noted, the choice to adopt vending machines 1 that are capable of preparing the beverage only after the user's request makes it possible to store, in the vending machine 1, the ingredients only, which occupy a considerably smaller space than the known vending machines and/or make it possible to store sufficient raw material to prepare a very high number of beverages (higher than the number in the bottles or cans that can be accommodated in the known machines).

This ensures a containment of logistics costs and makes it possible to offer vending machines 1 on the market at prices that are certainly attractive and competitive, which can be offered even in places where a high number of users is not expected, which would otherwise be necessary in order to ensure a profit margin.

It should moreover be noted that by means of the choice to adopt a purifying device 6 it is possible to ensure a constant supply of mineralized water (or the like) by using (in addition to the adapted preparation based on mineral salts) mains water and therefore without requiring constant interventions to refill the vending machine 1, thus lowering the running costs even if it is desired to use the vending machine 1 only for providing mineralized water (or the like).

This makes it possible to use the vending machine 1 according to the invention for providing mineralized water (or the like) and/or other beverages in small buildings too, for example in small condominiums and residential centers, thus giving the potential users (even if they are few in number) the opportunity to stock up on beverages without having to make a trip to the mall (with the consequent nuisance and discomfort associated with the need to transport bottles which are often bulky and heavy).

In addition it is possible to make at least the first portions 12 (and the second portions 14) from environmentally compatible materials, thus ensuring that the consumption of products dispensed by the vending machine 1 according to the invention is done in full compliance with the laws that regulate the disposal of the empty receptacles.

In this regard, moreover, the possibility of using the spout 8 for dispensing beverages makes it possible to completely eliminate the need of providing the user, for each product requested, with a corresponding container (which must subsequently be disposed of). By means of simple contrivances by the user himself or herself (for example reusing the same container) it is possible to reduce production and the problems of disposing of bottles and the like, fully respecting the environment.

In practice it has been found that the vending machine according to the invention fully achieves the set aim, in that the choice to use a main water tank, a storage compartment for at least one water-soluble preparation and at least one apparatus for mixing the preparation in water, makes it possible to provide vending machines that are capable of dispensing beverages with a simple and economical management of the supplies of products allocated therein.

The invention, thus conceived, is susceptible of numerous modifications and variations, all of which are within the scope of the appended claims. Moreover, all the details may be substituted by other, technically equivalent elements.

For example it is possible to have a further, ready-to-use tank 16, of smaller capacity than the main tank 3 and arranged downstream of it.

According to this embodiment (shown in FIG. 1) it is from this ready-to-use tank 16 that the water for mixing is drawn (or the mixing occurs directly therein). Thus it is possible to provide for the refrigeration (and/or the sanitization) of this tank only, thus further reducing the costs associated with the energy consumption of the vending machine 1. Purely for the purposes of non-limiting illustration, the possibility is noted that the main tank 3 has a volume of 501 (equal to 50 dm³), while the ready-to-use tank 16 has a volume of 11 (equal to 1 dm³).

Moreover, the main tank 3 (and/or the ready-to-use tank 16) can be connected to a level sensor, which in turn is connected to the electronic unit 2. The sensor is capable of sending a signal to the electronic unit 2, if the level of water inside the main tank 3 (and/or of the ready-to-use tank 16) falls below a preset threshold, so as to command the starting of the procedure to purify a quantity of water necessary to restore the desired level.

Finally, note that a drainage duct 17 is provided for the waste water, which is arranged downstream of the components described in the foregoing paragraphs and is capable of collecting liquids that may be discarded, in order to convey them preferably toward the sewage system.

In the embodiments illustrated, individual characteristics shown in relation to specific examples may in reality be interchanged with other, different characteristics, existing in other embodiments.

Moreover, it should be noted that anything found to be already known during the patenting process is understood not to be claimed and to be the subject of a disclaimer.

In practice, the materials employed, as well as the dimensions, may be any according to requirements and to the state of the art.

The disclosures in Italian Patent Application No. BO2010A000573 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-10. (canceled)

11. A vending machine, particularly for cold drinks, comprising at least one main water tank, at least one storage compartment for at least one water-soluble preparation and at least one apparatus for mixing said preparation in said water to provide a beverage, obtained by mixing said preparation in said water, dispensable to the outside.

12. The vending machine according to claim 11, wherein said preparation is selected from among at least one fruit-based concentrate for providing a beverage of the type of a fruit juice, a syrup for providing beverages of the type of a cola, a compound based on mineral salts to provide water of the type of mineralized water, table water, purified water, water with added salts, and the like.

13. The vending machine according to claim 11, further comprising a water purifying device, which is interposed between said main water tank, which is refrigerated, and a port for introducing mains water, which is provided in said vending machine and can be connected to a water mains.

14. The vending machine according to claim 13, wherein said purifying device is selected preferably from a reverse osmosis demineralizer, an electrode ionization demineralizer and an activated carbon filter.

15. The vending machine according to claim 11, further comprising at least one spout for dispensing the beverage, which is arranged downstream of said mixing apparatus and adapted to fill a container selected and provided by a user.

16. The vending machine according to claim 15, further comprising at least one receptacle for a plurality of containers and packaging means for each one of said containers, so that they can be filled with a predefined quantity of beverage, and optionally closed, prior to delivery to the user.

17. The vending machine according to claim 16, wherein each one of said containers is constituted substantially by at least one first portion and at least one closure, which can be stably associated with said first portion for the hermetic closure of said container, at least said first portions being stackable on top of each other for their storage in said receptacle in a configuration of minimum space occupation.

18. The vending machine according to claim 17, wherein each one of said first portions is substantially frustum-shaped, is open at its end faces for mutual stacking so as to form a column which is arranged in a substantially vertical manner, defining said minimum bulk configuration, each one of said containers comprising a second portion, which is adapted to close the respective lower end face of said first portion, to allow the filling of said container even in said minimum bulk configuration, said plug being adapted to close hermetically said container at the respective upper end face of said first portion.

19. The vending machine according to claim 16, further comprising a labeling assembly, for applying labels, which can also be preprinted, on at least one face of each one of said containers prior to their delivery to the user.

20. The vending machine according to claim 15, further comprising at least one source of ultraviolet radiation, which is directed toward at least one of said water purifying device, said spout and said packaging means, in order to sanitize them.
